(19) United States
(12) Patent Application Publication
(10) Pub. No.: US 2009/0241797 A1
(43) Pub. Date: Oct. 1, 2009

(54) Ecological Goods Logistics System

(76) Inventor: Flavio Costa, Ecublens (CH)

Correspondence Address: NIXON & VANDERHYE, PC, 901 NORTH GLEBE ROAD, 11TH FLOOR, ARLINGTON, VA, 22203, US

(21) Appl. No.: 12/412,710

(22) Filed: Mar. 27, 2009

Related U.S. Application Data
(60) Provisional application No. 61/040,695, filed on Mar. 30, 2008.

(51) Int. Cl. B61B 1/00

(52) U.S. Cl. 104/29; 705/28

(57) ABSTRACT

A system for transporting goods uses public transportation infrastructure. The public transportation infrastructure includes rolling stock, transportation networks for the rolling stock, and passenger platforms. The goods transporting system includes a plurality of containers that receive the goods for transport, and container space in the rolling stock that is sized to receive the containers. The container space is either additional rolling stock or dedicated space in the existing rolling stock of the transportation infrastructure. Goods platforms are provided separate from the passenger platforms. When the rolling stock comes to a station stop, the container space is positioned near the goods platforms. The system also includes structure for moving the containers on and off the rolling stock, and structure for controlling the loading/unloading assemblies to load/unload the containers on/from the rolling stock according to a desired destination for the goods in the respective containers.

### CROSS-REFERENCES TO RELATED APPLICATIONS

This application claims the benefit of U.S. Provisional Patent Application Ser. No. 61/040,695, filed Mar. 30, 2008, the entire content of which is herein incorporated by reference.

### STATEMENT REGARDING FEDERALLY SPONSORED RESEARCH OR DEVELOPMENT

(NOT APPLICABLE)

### BACKGROUND OF THE INVENTION

More and more often large cities and urban areas feel the need to limit access and circulation of private fuel propelled vehicles in order to avoid annoyances like air pollution, traffic congestion, noise, etc. Most important strategies used are twofold: on one side usage of private vehicles is disfavored (high parking charges, tolls for access to certain areas, restrictions to circulation, etc.). On the other side, public transport is offered as an alternative for passenger transport (mass transportation authorities). In fact, public transport has usually a much lower negative impact on quality of life, at least as far as some aspects (like pollution of the cities, traffic congestion, etc.) are concerned, compared to private fuel propelled vehicles.

This double strategy has proven rather successful in reducing the circulation of private vehicles. However it has an intrinsic limitation: basically no alternative to fuel propelled vehicles (trucks, lorries, etc.) is offered for the transport of goods, materials, etc.

In fact, actions to limit the circulation of commercial vehicles have to take into account the economical and social effects that they would have on the areas to which they apply (including disappearing of shops and commercial centers/malls, but also increased costs in garbage collection and all other activities involving the transport of materials and goods).

Limitations put in place up to now have had limited results on goods transport (in any case in comparison with passenger transport). Fees and tolls are usually quickly “absorbed” by the distribution chain with no major impact. The financial burden moves quickly from direct actors (the transporter, the logistics chain) to end users (the customers), splitting evenly and very finely, hence much imperceptibly (the fee for one load is spread on hundreds of sales units; it could be thousands per load).

Even interdictions and restrictions to circulation and load/unload operations have proven limited success on goods transport. Sometimes they have even caused perverse reactions which generated an effect opposite to what was expected. The logic followed in practice seems clear: business asks for goods in city centers and urban areas. Hence the distribution system will adapt and manage to get the goods there with fuel propelled vehicles at virtually any condition, as long as there is no valid alternative.

Today there is no alternative to fuel propelled vehicles for mass transport of goods in urban areas. Pushed by restrictions, constraints and environment concerns, some new ways of distributing goods in urban areas have indeed been developed in the past years:

light trucks/lorries moved by electrical motors, with very limited pay load and autonomy due to technical constraints

cyclists delivering parcels and small packages, with very limited pay load due to human capabilities

tramways used to deliver goods (Dresden(D), Zurich(CH), etc.), with very limited application because of conflicts with passenger service, traffic congestion (surface service), etc.

All of the above have proven not to be able to cover more than some niche market needs. Cities and urban areas ahead in the politics of traffic reduction will soon come to the point where circulation of fuel propelled private vehicles for passenger transport will be virtually suppressed. In spite of that, pollution and traffic congestion in these areas will still be much higher than expected (or desired) because of the fuel propelled vehicles used for the transport of goods. No reasonable means to go further in traffic reduction will be available to the administrators of these cities and urban areas, as far as it is in sight today.

### BRIEF SUMMARY OF THE INVENTION

The system of the described embodiments intends to provide an alternative to fuel propelled vehicles for goods transport in urban areas. In fact, the system is intended to increase the quality of life in urban and suburban areas, decrease pollution and waste of energy and resources by providing efficient, flexible, precise and reliable goods transport. It solves a good part of the major problems linked to goods transport (traffic congestion, pollution, social costs, etc.) of medium to large size urban areas in the world (and, once sufficiently generalized, could be applied and solve similar problems of smaller and smaller cities and urban areas). It is based on existing infrastructures and technology, hence its financial cost is particularly constrained, precisely foreseeable and easy to pay-off (in particular if external, “social” costs are accounted, too). Moreover, it does not present major risks or uncertainties from the technology, construction and exploitation points of view.

The system effects the transport of goods using mass transport infrastructure commonly used until today only for the transport of passengers. This new system has capacity that can match the goods transport needs of big cities and large urban areas and therefore represents a valid alternative to the present goods distribution system, which is mainly based on fuel propelled vehicles.

The system allows mass passenger transport companies (mass transport authorities) to commercialize a new product. The system integrates the classically conceived infrastructure and system dedicated to mass passenger transport, with an automatic system for the transport, stock and delivery of goods. It applies both to existing transportation infrastructure and to new infrastructure. The system is based on the idea of providing goods distribution (in a broad sense) in, to and from urban areas in combination with mass passenger transportation using infrastructure commonly used until now only for the transport of passengers.

To do that, the system takes advantage of the high frequency of the transit of the rolling stock (generally “subway trains” or similar trains, in one possible and most likely embodiment, but may also include vehicles, aerial trams, above-ground trains, etc.) and of modern exploitation techniques which allow a high degree of automation of the operations needed for the transport of the goods. This in turn allows a high compatibility with the present exploitation of the mass transport system for passengers, hence with negligible (if any) impact on the latter. This is a major asset for the applicability of the idea, given the conditions at which these types of mass transport systems often operate.

In an exemplary embodiment, a system for transporting goods uses public transportation infrastructure. The public transportation infrastructure includes rolling stock, transportation networks for the rolling stock, and passenger platforms. The goods transporting system includes a plurality of containers that receive the goods for transport, and container space in the rolling stock that is sized to receive the containers. The container space is one of additional rolling stock or dedicated space in the rolling stock of the transportation infrastructure. Goods platforms are provided separate from the passenger platforms. When the rolling stock comes to a station stop, the container space is positioned near the goods platforms. The system also includes structure for moving the containers on and off the rolling stock, and structure for controlling the loading/unloading assemblies to load/unload the containers on/from the rolling stock according to a desired destination for the goods in the respective containers.

In another exemplary embodiment, a method for transporting goods uses public transportation infrastructure. The method includes the steps of providing a plurality of containers that receive the goods for transport; providing container space in the rolling stock that is sized to receive the containers, wherein the container space includes one of additional rolling stock or dedicated space in the rolling stock of the transportation infrastructure; positioning goods platforms, separate from the passenger platforms, such that when the rolling stock comes to a station stop, the container space is positioned near the goods platforms; selectively moving the containers on and off the rolling stock; and causing the loading/unloading assemblies to load/unload the containers on/from the rolling stock according to a desired destination for the goods in the respective containers.

### BRIEF DESCRIPTION OF THE DRAWINGS

These and other aspects and advantages will be described in detail with reference to the accompanying drawings, in which:

FIG. 1 schematically represents an exemplary typical but not exclusive embodiment of the system which could typically be placed at surface level; and

FIG. 2 schematically represents an exemplary typical but not exclusive embodiment which could commonly be installed at underground level.

### DETAILED DESCRIPTION OF THE INVENTION

The system of the described embodiments intends to provide transport of goods in urban areas in a highly automated way with transport time and operating costs usually comparable or better than today's fuel propelled vehicle based transport. The system could be applied also to fuel propelled vehicles (e.g. buses), with limited, partial advantages.

Important advantages of the system compared to existing systems are:

massive reduction of air pollution

massive reduction of traffic congestion

reduction of noise

significant improvement of efficiency and considerable reduction of energy consumption with equivalent general performances

considerable increase of traceability and timeliness of the transport.

The system embodies a new process providing a new product based on mass passenger public transportation systems. The resulting system requires limited adjustments to infrastructure commonly used for the transport of passengers. It is based on the integration of existing modern technologies and devices assembled in a new way, as never done before. The resulting system integrates the infrastructure and vehicles dedicated to mass passenger transport, with an automatic system for the transport, stock and delivery of goods. It can be applied both to already existing transportation systems and to new infrastructure.

Typical (but not exclusive) references for these infrastructures are mass passenger transportation systems commonly known as “Underground”, “Tube” or “Subway” in English, “Mètro/Mètropolitain” or “RER” in French, “U-Balni” or “S-Bahn” in German, “Metro” or “Cercanias” in Spanish, etc. The concepts apply also to other mass passenger transportation systems, including services based on fuel propelled vehicles (e.g. buses), whose exploitation of the service is compatible with the transport of goods and materials in the ways and at the conditions described hereunder. Generally a good part of the infrastructure of the mass transport systems will be physically underground (and an underground embodiment will be often used as a reference in this description), but the principle can be applied as well to non-physically underground infrastructures. The concepts also apply to hybrid cases (that is, lines or network of lines partially underground and partially on the surface), to completely open-air/surface lines or networks of lines and even to infrastructures elevated from the earth's surface and any combinations of the previous and other types of infrastructures.

The method is based on providing goods (in a broad sense) distribution in urban areas in combination with mass passenger transportation systems. To do that, the method takes advantage of the relatively high frequency of the transit of the rolling stock (generally “underground trains” or similar trains) and of the geographical distribution of the mass passenger transportation networks.

The system can be considered as composed of two main parts:

Hardware: includes rolling stock and stations, where the handling, transport and stock of the goods is done with an extremely high degree of automation and in a flow safely separated from the passenger flow; and

Software: includes an information system which allows the automation of the whole process (goods handling, transport, stock, etc.).

A more detailed description of the two parts follows, together with a description of the most typical (but not exclusive) phases of its functioning, for a typical but not exclusive embodiment integrated in a common underground rail based mass transportation system.

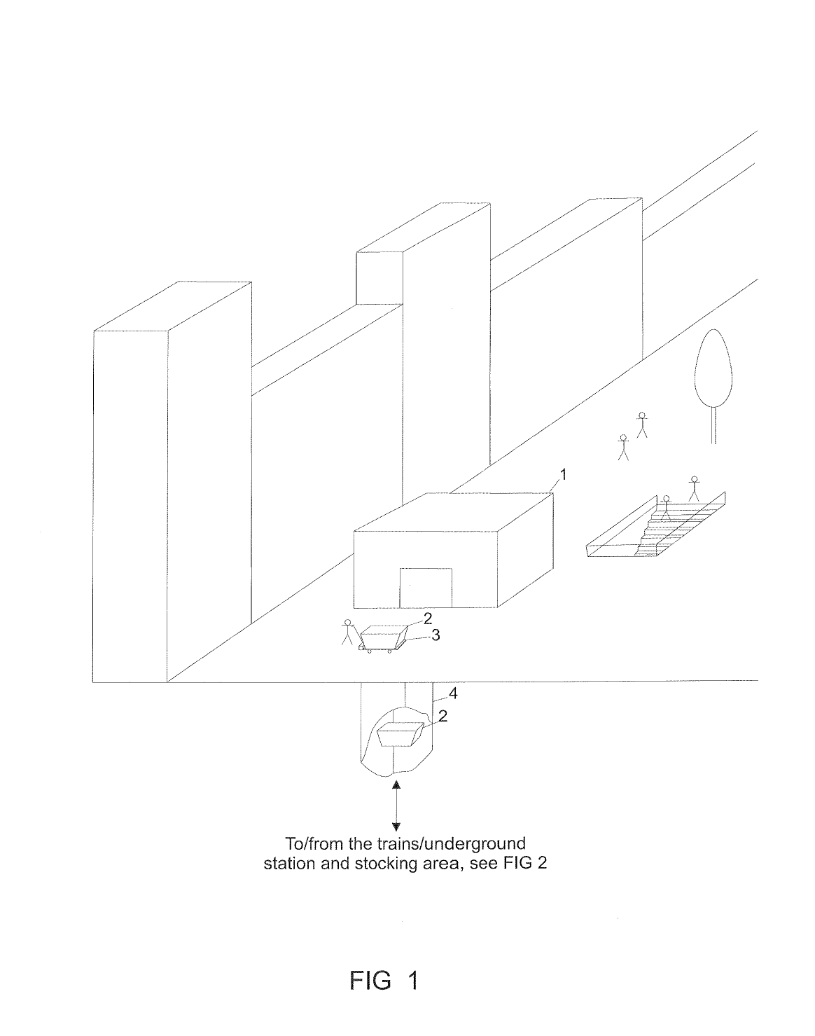

FIG. 1 shows how the transport of containers (2) of the goods to/from a “logistics interface” (1) area could take place in a typical urban environment. The “logistics interface” (1) area is sketched as a building above the surface. Mechanisms and elements (4) (such as lifts, traveling cranes, conveyors, etc.) allowing the unmanned transfer of the containers (2) between the “logistics interface” (1) area, stocking area (8) and a “goods platform” area (5) are shown. As a reference, some of the typical elements of structures dedicated to passengers transport (e.g. stairs) are also shown.

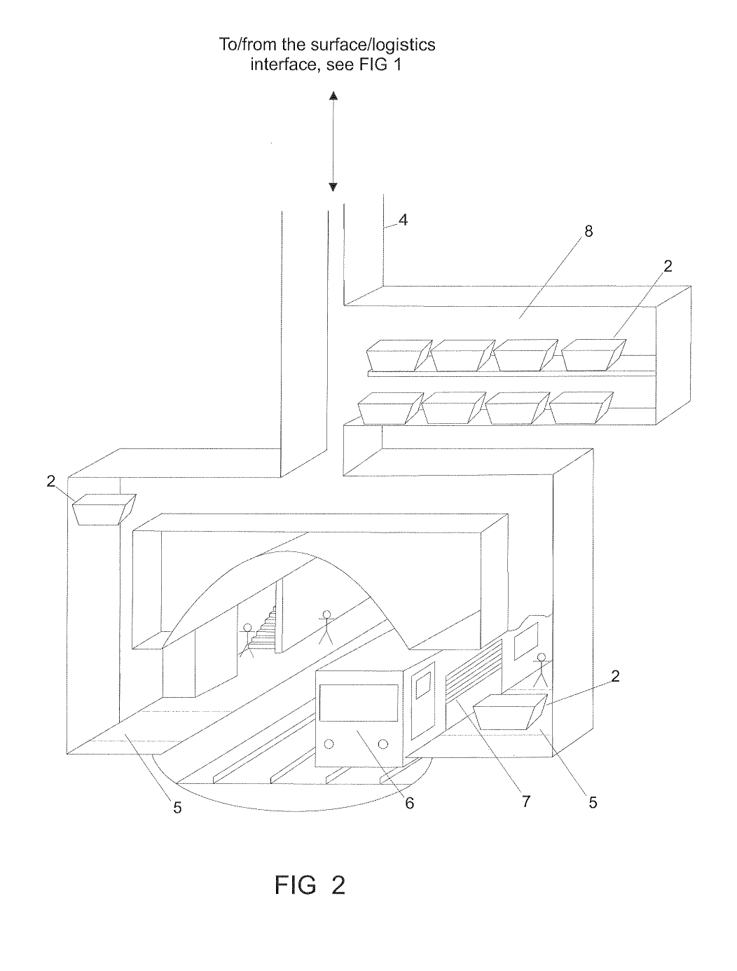

FIG. 2 shows an instant in the loading (/unloading) phase (see 3.3 below for a detailed description of this phase of the functioning), when a train (6) has just stopped and the doors (both passenger doors and goods cars doors (7)) are opening or going to open, in an underground type of station. FIG. 2 also represents an instant after the loading/unloading of passengers and goods, when the doors (both passengers' doors and goods cars doors (7)) are just closed or ready to be closed to let the train (6) start.

The separation between the passengers' platform and the “goods platform” area (5) and other details and elements are not shown. A part of the mechanisms to automatically transfer the containers (2) between the “goods platform” area (5) and the “logistics interface” area (1) is shown schematically.

1. Hardware

1.1 Rolling stock. The system is based on the use of a car adapted to the transport of containers (2). Its external and general characteristics are similar to cars commonly used in mass passenger transportation systems, although the “doors” (7) allow the entrance and exit of goods containers (2) (two containers per car in most cases, but according to local characteristics it could be one, three or more).

Because of exterior characteristics and general resemblance to the passenger cars of the goods cars dedicated to goods, the word “car” is used, although from the functional point of view, other words (“wagon”, etc.) are often used to indicate cars dedicated to the transport of goods.

The car may be adapted for driving (that is, including a cabin) and/or powered, according to needs. According to cost/exploitation/opportunity and other considerations, the car could replace a “classic” passenger car or be added to the normal train composition. In the latter case it increases the total length of the train (6). Those of ordinary skill in the art would recognize that all trains (6) may be equipped with goods cars or only a part of them, according to various needs and considerations.

In particular cases, the system can be adapted for the exploitation of more than one goods car per train (6), of one (or more) car(s) partially reserved for the transport of goods (and partially for the transport of passengers, the staff, etc.), or even of trains (6) with only goods cars, possibly in combination with other types of trains (6). The interior of the car is equipped with needed mechanisms for the automatic load and unload of the containers (2) at stations and for their safe transport. As much as on existing systems, a signal orders the opening of the doors to let the passengers in and out, a series of signals may be automatically and timely sent and allow, for example, to unblock the container (2) from a transport position, subsequently to activate one or more actuators (electromagnetic, pneumatic or other types) pushing the container (2) outside the car, onto the goods platform (5).

As per prior art, the action of actuators is combined with devices like roller conveyors installed in the car, in the goods platform area (5), etc. Detectors and sensors acknowledge and confirm the movements of the container (2) and the status of parts of the system. For example, the goods platform area (5) sensors will confirm that the container (2) is in place, thanks to the detection of its weight, for example, and/or identify the container (2) via RFID (Radio Frequency Identification) or bar code reading. This in turn will possibly allow sending the signal to actuators installed in the goods platform area (5), which will move the container (2) to lifts, other rollers, belt, overhead, vertical conveyors or other devices (4). Sensors and detectors in the lifts, for example, will acknowledge/confirm that the container (2) is correctly moved into the lift and trigger the operation of the lift in order to have it transferred to another goods platform area (5) (e.g., in case of correspondence with a connecting train), or to the logistics interface area or possibly to the stocking areas. Various types of conveyors and other exemplary loading/unloading mechanisms available from Bastian Material Handling of Indiana, for example, may be suitable, with few adaptations.

1.2 Containers: Any container (2) adapted to the transport of goods and compatible with the operations foreseen by the system is suitable. For standardization/efficiency/multimodality and other reasons, a good reference could be one (or more) of the ULD (Unit Load Device) defined by IATA (International Air Transport Association), perhaps with adjustments. Other types of containers (2) could be used.

The same line or network of lines could use different containers (2), that is, containers intended and adapted to specific purposes, according to transport, safety, health constraints and/or other needs. All different types of containers (2) shall anyway be compatible with other components of the system. Size and other characteristics of the containers (2) shall usually take into account also the needs and constraints of limited or costly room available in specific situations (e.g. centers of cities), of ecological/zero emission transport of the containers (2) even outside the system (e.g. streets) (3), of the needs of relatively small customers (e.g. shops), etc.

1.3 Stations: Stations have a special “goods platform” area (5), usually contiguous to the passenger platform area and protected from passenger access (at least and in any case during exploitation of the goods transport service). At the “goods platform” area (5), the automatic load and/or unload of the container(s) (2) takes place, for the car(s) which is (are) intended to carry the containers (2). The “goods platform” areas (5) can be fitted to operate with one or more goods cars at a time. The basic idea is that the containers (2) are operated at the same time and during a typical passenger stop of common mass transportation systems. Nevertheless, in particular cases the load and/or unload of the container(s) (2) may take place “uncoupled” from the passenger service and for the goods cars of the same train (6) may be operated in subsequent times or simultaneously (that is, more cars loaded and/or unloaded at the same time).

From the “goods platform” area (5) a mechanism (4) allows the automatic transport of the containers (2) to/from the “logistics interface” area (1) where the containers (2) are collected, delivered, prepared, etc. This mechanism (4) may include lifts, traveling lifts, elevators, loading bridges, overhead cranes, conveyors and other devices. The mechanism (4) allows the automatic transport of the container (2) within the system in order to accomplish various functions. A not exclusive list of these functions includes:

1.3.1 load/unload the containers (2) and transport them between the trains (6) and the “logistics interface” area (1) where they are (temporarily) stocked, received (station of origin) or delivered (station of destination) to/from the customer

1.3.2 load/unload the containers (2) and transport them between trains (6) of different lines at stations where different lines cross, in order for the containers (2) to reach their destination or for the flexibility of the logistics needs

1.3.3 load/unload the containers (2) and transport them between trains (6) of opposite directions, for the flexibility of the logistics needs

1.3.4 other functions needed to operate the system efficiently, optimize its capacity and grant maximum flexibility in case of partial disruptions of the infrastructures and other parts of the system, congestion in the use of the system, etc.

A given station may provide a full set of the functions or a subset, in various combinations.

Stations may have one or more “logistics interface” (1) areas, which are halls (underground, partially underground, at the surface, elevated or any mix of the preceding and other situations, depending on geographical and other specific conditions) where containers (2) are stocked, delivered or received by/for the customers or intermediaries or where the load is manipulated.

Stations may accept and deliver entire containers (2) or smaller loads, depending on organization, infrastructure, costs and other considerations. Smaller loads can be grouped in order to optimize the transport and handling of the containers (2), according to the services provided at the station (and, more widely, by the organization of the system). Stations may be linked to warehouses, production plants, supermarkets, garbage collector centers or other sites where all (or part of) the loads to be transported from/to that station are collected, produced, consumed, distributed, stocked, etc. In these cases, the system can integrate with other logistics systems, at various levels of optimization and automation, via the station's “logistics interface” (1) and the information system.

Stations may have also a stocking area (8), an area where containers (2) can be temporarily stored before or after the transport (and before or after the delivery to/from the customer). The stocking area (8) can be physically integrated to the “logistics interface” area (1), the “goods platform” area (5) or only connected to them, although physically separated. In some cases, stations may not have any stocking areas (8).

2. The Software Part

The Software part is the entire information system which allows the automation of the handling, transport and stock of the goods and possibly the interaction with customer information systems and other information systems (for administration, etc.). The information system includes functions and tools to track each container (2) used in the system, its movements and possibly its content. The information preferably allows:

full traceability of the movements of each container (2) in real-time

just in time delivery at a very precise/fine level (usually within the order of magnitude of minutes or less)

manage and optimize the entire system logistics (stock and transport) capacity, taking into account the following main issues (amongst other ones):
“traffic load” of the whole system and single components
limitations in stock, transport and handling capabilities of particular elements of the system (station, trains (6), etc.)
tolerances of the “just-in-time” deliveries, according to contractual rules with the customer
temporary disruption of some elements of the system (lines or part of lines of the network, trains (6), stations, etc.)

account fees and costs, possibly interfacing with other information systems (for invoicing, accounting, etc.)

and/or other functions.

The information system contains and processes the information related to common exploitation of mass passenger transportation systems (theoretical and actual timetables, schema of the network and of served stations, etc.). In addition, it handles needed information related to goods transport service, such as characteristics of various elements of the system (storage capacity in the stocking areas (8), functions available at each station to handle the containers (2), number of containers (2) that can be carried by train (6), time to transfer containers (2) for all functions available at stations, etc.) and also dynamic information, possibly collected via sensors and detectors (position and transit of containers (2) at different points of the system, real time availability of places in stocking areas (8), on trains (6), etc.). Sensors and detectors can be of various types, and possibly different types could be used in the same application. A non-limiting list includes weighing devices, mechanical detectors of movements (for example switches activated mechanically by the container (2) touching certain parts or devices), optical detectors (including bar code readers) or RFID (Radio Frequency Identification), etc.

The information system evaluates the above mentioned information to control availability of different elements of the system such as: room that will be available on a given train (6) at a given station for one of the next runs in order to meet the need to load a container (2) that just entered the system at that station, check availability of room in a given station at a given time in order to receive the container (2) that has to be delivered there, etc. The information system also plans the transport of the containers (2) while optimizing the overall use of the system, computes the information needed to station operators and to customers for just-in-time delivery, orders the different operations of the devices of all the elements of the system (for example to move the containers (2) within stations, to load/unload the containers (2) onto/from the trains (6), etc.), and grants the run of the whole goods transport service.

3. Functioning

The following is a general, exemplary description of the main steps by which loads are transported via the system in one possible implementation. All possible variants (some of which referred to in the previous description under 1. “Hardware” and 2. “The Software part”) are not described.

3.1 Origin of the Transport

The “logistics interface” area (1) of the station is where the load enters the system. At this time the information regarding the transport of the load is entered in the information system (or imported and/or confirmed in case of a load coming from an external logistics system). The system calculates the path, delivery time, etc., according to the availability and conditions of the network. The load can be a container (2) agreed for use in the system or a smaller load which is possibly combined with other loads into a container (2), according to service foreseen by the system, the specific station, etc. Depending on several considerations this phase 3.1 shall be accomplished entirely automatically or partly manually. The next steps 3.2 through 3.6 are normally accomplished with no human intervention (except for failures, etc.).

3.2 Automatic Handling at the Origin Station

After the operations described at the point 3.1 above, the system will handle the container (2) with no human direct intervention (except for failures, etc.). Depending on the scheduled time for the next train (6) with available room, the room available in the station and other parameters, the system may move the container (2) temporarily to a stocking area (8). In any case, when the information system receives the information (from the classical train security system, ATP (Automatic Train Protection) system, ATO (Automatic Train Operation) system, etc.) that the train (6) scheduled to load the container (2) is the next one to approach the station in the planned direction, the system will move the container (2) to the “goods platform” area (5). Here the container (2) will wait the approaching train (6), usually for a very short amount of time.

3.3 Automatic Load (and Unload) on the Train (6)

When the train (6) enters the station, it slows down and stops on the automatic brake in the exact place (with usual tolerances, according to modern, common techniques for automatic operation of mass passenger transportation systems) to allow the automatic load of the container (2). The “doors” (7) of the goods car will open at about the same time when the doors of the passenger cars open. The container (2) is loaded in the car at the same time when passengers get on and off from the contiguous passenger platform to passenger cars or vice versa. Possibly (if the goods car and the “goods platform” area (5) foresee it) other containers (2) can be loaded and one (or more) other container(s) (2) may be loaded/unloaded from the train (6) to the “goods platform” (5), at the same time. The load and unload operations are no longer than the usual time required for the loading/unloading of the passengers (usually in the order of tens of seconds). The “doors” (7) of the goods car(s) close at about the same time as the doors of the passenger cars. The train (6) can start and leave the station.

3.4 Transport and Intermediary Handling of the Containers

The container (2) will travel on the same goods car until its final station in the simplest case, where the origin and destination stations are served by the same line and the same train (6) (and in case there are no particularly difficult traffic conditions). Otherwise a change of line and/or train (6) may be required, possibly at correspondence stations (as per function described in 1.3.2). In this case, the container (2) will be unloaded upon the arrival of the train (6) at the corresponding station as described in 3.3. The transfer mechanism driven by the information system will move the container (2) to the “goods platform” area (5) (possibly via a more or less long stop in a stocking area (8), according to various considerations and needs) where the corresponding train (6) will stop. When the corresponding train (6) will arrive, loading takes place, as described in 3.3. The container (2) will arrive at the final station, possibly via other correspondences, following the path, stops and on board of the trains (6) scheduled by the information system, possibly taking into account partial disruption in the mass passenger transportation network and/or other unforeseen problems.

3.5 Automatic Unload from the Train (6)

At the arrival station, the container (2) is unloaded from the train (6) onto the station “goods platform” area (5) as described in 3.3.

3.6 Automatic Handling at the Final Station

The container (2) will be moved to the “logistics interface” area (1) of the station, following the steps and considerations as described in 3.2 (but basically in reverse order).

3.7 Final Operation and End of the Transport within the System

At the “logistics interface” area (1) the load is delivered (either automatically or manually) to the customer (or to the customer's premises via the linked external logistics system), possibly after a temporary stop in the stocking area (8), according to a planned time for the delivery of the container (2) and as ordered by the information system.

Various loads transported in the container (2) are possibly extracted and distributed to various third parties, according to agreements and service foreseen by the specific implementation of the system or the given station.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A system for transporting goods using public transportation infrastructure, the public transportation infrastructure including rolling stock, transportation networks for the rolling stock, and passenger platforms, the goods transporting system comprising:
a plurality of containers that receive the goods for transport;
container space in the rolling stock that is sized to receive the containers, wherein the container space comprises one of additional rolling stock or dedicated space in the rolling stock of the transportation infrastructure;
goods platforms separate from the passenger platforms, wherein when the rolling stock comes to a station stop, the container space is positioned near the goods platforms;
loading/unloading assemblies cooperable with the containers, the container space, and the goods platforms, the loading/unloading assemblies moving the containers on and off the rolling stock; and
an information system communicating with the transportation infrastructure, the loading/unloading assemblies, and the plurality of containers, the information system causing the loading/unloading assemblies to load/unload the containers on/from the rolling stock according to a desired destination for the goods in the respective containers.

2. A system according to claim 1, further comprising a plurality of stocking areas positioned near the goods platforms, the stocking areas storing empty containers for subsequent use and storing containers with goods during transit.

3. A system according to claim 2, wherein the loading/unloading assemblies are cooperable with the stocking areas to move the containers to/from the rolling stock from/to the stocking areas via the goods platforms.

4. A system according to claim 2, wherein the information system comprises a stock component that monitors the containers in the stocking areas and determines a storage capacity of the stocking areas.

5. A system according to claim 1, wherein rolling stock is a train, and wherein the container space comprises a train car.

6. A system according to claim 1, wherein the goods platforms are contiguous to the passenger platforms.

7. A system according to claim 1, wherein the loading/unloading assemblies comprise at least one of lifts, elevators, loading bridges, conveyors and cranes.

8. A system according to claim 1, further comprising a logistics interface area that temporarily stores the containers for transport, the containers in the logistics interface area are one of stocked in the logistics interface area, received as a station of origin in the logistics interface area, or delivered as a station of destination in the logistics interface area.

9. A system according to claim 1, wherein the information system comprises a stock component that monitors the containers and determines a storage capacity of locations for the containers in transit.

10. A system according to claim 1, wherein the loading/unloading assemblies comprise moving structure that connects the rolling stock on one line in the transportation network to the rolling stock on another line at the same station, wherein the information system causes the loading/unloading assemblies to load/unload the containers from one car of the rolling stock to another car of the rolling stock.

11. A system according to claim 1, wherein the information system comprises a tracking component that tracks movement of each of the plurality of containers.

12. A system according to claim 11, wherein the tracking component tracks content of each of the plurality of containers.

13. A system according to claim 1, wherein the information system comprises a logistics component that maps, monitors and optimizes movement of the containers.

14. A system for transporting goods using public transportation infrastructure, the public transportation infrastructure including rolling stock, transportation networks for the rolling stock, and passenger platforms, the goods transporting system comprising:
a plurality of containers that receive the goods for transport;
container space in the rolling stock that is sized to receive the containers, wherein the container space comprises one of additional rolling stock or dedicated space in the rolling stock of the transportation infrastructure;
goods platforms separate from the passenger platforms, wherein when the rolling stock comes to a station stop, the container space is positioned near the goods platforms;
means for moving the containers on and off the rolling stock; and
means for controlling the loading/unloading assemblies to load/unload the containers on/from the rolling stock according to a desired destination for the goods in the respective containers.

15. A method for transporting goods using public transportation infrastructure, the public transportation infrastructure including rolling stock, transportation networks for the rolling stock, and passenger platforms, the method comprising:
providing a plurality of containers that receive the goods for transport;
providing container space in the rolling stock that is sized to receive the containers, wherein the container space comprises one of additional rolling stock or dedicated space in the rolling stock of the transportation infrastructure;
positioning goods platforms, separate from the passenger platforms, such that when the rolling stock comes to a station stop, the container space is positioned near the goods platforms;
selectively moving the containers on and off the rolling stock; and
causing the loading/unloading assemblies to load/unload the containers on/from the rolling stock according to a desired destination for the goods in the respective containers.
